(19) United States
(12) Patent Application Publication
(10) Pub. No.: US 2019/0226656 A1
(43) Pub. Date: Jul. 25, 2019

(54) LIQUID CRYSTAL ELEMENT AND ILLUMINATION DEVICE

(71) Applicant: STANLEY ELECTRIC CO., LTD., Tokyo (JP)

(72) Inventors: Yasuo TOKO, Yokohama-shi (JP); Yoshihisa IWAMOTO, Yokohama-shi (JP)

(73) Assignee: STANLEY ELECTRIC CO., LTD., Tokyo (JP)

(21) Appl. No.: 16/254,931

(22) Filed: Jan. 23, 2019

(30) Foreign Application Priority Data
Jan. 24, 2018 (JP) 2018-009808

(51) Int. Cl. F21S 41/64; F21S 41/25; G02F 1/1337; G02F 1/137

(52) U.S. Cl. CPC F21S 41/645; F21S 41/25; G02F 1/1337; F21S 41/143; G02F 2001/133742; G02F 2001/13712; G02F 1/137

(57) ABSTRACT

A liquid crystal element comprises: a first substrate and a second substrate disposed substantially in parallel to each other to face each other, an electrode and a homeotropic alignment film being disposed on each of facing surfaces of the first substrate and the second substrate; and a liquid crystal layer disposed between the first substrate and the second substrate and formed of a liquid crystal material having a negative dielectric-constant anisotropy, wherein a twisting angle of the liquid crystal layer when a voltage is applied between the electrode of the first substrate and the electrode of the second substrate is in a range from 70° to 120°.

### CROSS REFERENCE TO RELATED APPLICATION

This application is based on and claims priority on Japanese Patent Application No. 2018-009808, filed on Jan. 24, 2018, the entire contents of which are incorporated herein by reference.

### FIELD OF THE INVENTION

The present invention relates to a liquid crystal element and an illumination device using the liquid crystal element.

### BACKGROUND

Vehicular headlights capable of controlling illumination regions are known.

For example, in recent years, a light-distribution changeable headlamp (or an adaptive driving beam, ADB) is getting attention among vehicular headlights. The ADB controls a light-distribution shape on a real-time basis depending on forward circumstances, more specifically, the presence of an oncoming vehicle and a leading car, and their positions. With the ADB, for example, when an oncoming car is detected during driving with high beams, only light directed toward the region of the detected oncoming vehicle can be reduced on a real-time basis among light directed toward regions illuminated by headlights. The ADB provides a field of view close to circumstances of illumination with high beams for the driver whereas the ADB prevents glare from being given to the oncoming car.

In addition, a headlight system (or an adaptive front-lighting system, AFS) that controls light distribution in a traveling direction depending on the steering angle of a steering wheel is being popular. The AFS moves a light-distribution shape in a left-right direction depending on the steering angle of the steering wheel to expand a field of view in the traveling direction.

The vehicular headlights whose illumination regions are controllable each include, for example, a light-emitting unit including multiple light-emitting diode (LED) elements that are arranged in an array, and a projector lens arranged in an optical path of the light emitted from the light-emitting unit. Each LED element is independently controlled. More specifically, an electrical conduction state and an electrical non-conduction state (on and off) of each LED element, applied current in the electrical conduction state, and so forth, are controlled on a real-time basis, and a lighting pattern of the LED element (an outgoing light pattern of the light-emitting unit) is formed. Accordingly, a predetermined light-distribution pattern is formed forward of the vehicle.

There is known vehicular headlights each including a dimming unit in an optical path between a light-emitting unit and a projector lens (for example, Japanese Laid-open Patent Publication No. 2005-183327).

In the vehicular headlights described in Japanese Laid-open Patent Publication No. 2005-183327, the light emitted from the light-emitting unit using LED elements is incident on an electrical optical element having a dimming function, for example, a light-shielding unit using a twisted nematic (TN) liquid crystal element (or liquid crystal display, LCD). The light-shielding unit controls the dimming of the electrical optical element. More specifically, the light-shielding unit (partly) controls the transmittance of the liquid crystal element depending on the position to control light distribution. Changing the light-transmitting and light-shielding positions changes the shape of the light-distribution pattern. For example, a cutoff pattern is formed.

However, the light-distribution state in the light body is a wide angle state. For example, light is incident on a liquid crystal element in a direction inclined by about 30° with respect to the direction normal to the liquid crystal element (substrate normal direction). Since the TN liquid crystal element has poor performance in viewing angle, its contrast ratio markedly decreases.

Using a homeotropic liquid crystal element can improve viewing angle characteristics. However, if a liquid crystal element fabricated under normal-use conditions is used, the transmitted light is likely colored yellow. The transmitted light of a liquid crystal element may turn yellow depending on the voltage application conditions. The transmitted light may turn yellow also depending on the viewing angle. Light transmitted through a liquid crystal layer has substantially different retardations. Light that is incident in the direction normal to the liquid crystal element (substrate normal direction) less likely turns yellow, and light that is incident in an oblique direction likely turns yellow.

### SUMMARY

According to an aspect of this invention, there is provided a liquid crystal element comprising: a first substrate and a second substrate disposed substantially in parallel to each other to face each other, an electrode and a homeotropic alignment film being disposed on each of facing surfaces of the first substrate and the second substrate; and a liquid crystal layer disposed between the first substrate and the second substrate and formed of a liquid crystal material having a negative dielectric-constant anisotropy, wherein a twisting angle of the liquid crystal layer when a voltage is applied between the electrode of the first substrate and the electrode of the second substrate is in a range from 70° to 120°.

According to another aspect of this invention, there is provided a liquid crystal element comprising: a first substrate and a second substrate disposed substantially in parallel to each other to face each other, an electrode and a homeotropic alignment film being disposed on each of facing surfaces of the first substrate and the second substrate; and a liquid crystal layer disposed between the first substrate and the second substrate and formed of a liquid crystal material having a negative dielectric-constant anisotropy, wherein a chiral agent is added to the liquid crystal layer such that d/p is 0.25 or more and 0.4 or less where d is a thickness of the liquid crystal layer and p is a chiral pitch.

According to further another aspect of this invention, there is provided an illumination device comprising: a light source that emits light; a liquid crystal element disposed in an optical path of the light emitted from the light source, the liquid crystal element including, a first substrate and a second substrate disposed substantially in parallel to each other to face each other, an electrode and a homeotropic alignment film being disposed on each of facing surfaces of the first substrate and the second substrate, and a liquid crystal layer disposed between the first substrate and the second substrate and formed of a liquid crystal material having a negative dielectric-constant anisotropy, a chiral agent being added to the liquid crystal layer such that d/p is 0.25 or more and 0.4 or less where d is a thickness of the liquid crystal layer and p is a chiral pitch; and a lens on which light emitted from the liquid crystal element is incident, the lens having a focal point at a position near an arrangement position of the liquid crystal element.

The object and advantages of the invention will be realized and attained by means of the elements and combinations particularly pointed out in the claims.

It is to be understood that both the foregoing general description and the following detailed description are exemplary and are not restrictive of the invention, as claimed.

### BRIEF DESCRIPTION OF THE DRAWINGS

FIG. 1 is a schematic view of a basic configuration of an adaptive driving beam using a liquid crystal element.

FIGS. 2A and 2B are graphs of changes in spectrum with respect to driving voltages of a liquid crystal element with a chiral agent added and a liquid crystal element without a chiral agent.

FIGS. 3A and 3B are graphs of changes in response and changes in maximum transmittance with respect to changes in temperature of the liquid crystal element with the chiral agent added and the liquid crystal element without a chiral agent.

FIGS. 4A and 4B are graphs of changes in applied voltage-transmittance characteristics with respect to changes in temperature of the liquid crystal element with the chiral agent added and the liquid crystal element without a chiral agent.

FIGS. 5A and 5B are graphs of applied voltage-transmittance characteristics before and after alignment correction of the liquid crystal element with the chiral agent added.

FIG. 6 is a graph of applied voltage-transmittance characteristics of fabricated liquid crystal elements.

FIGS. 7A and 7B are chromaticity diagrams of changes in chromaticity with respect to applied voltages of a liquid crystal element (cell thickness: 6 μm) without a chiral agent and a liquid crystal element (cell thickness: 6 μm) with a chiral agent added. FIGS. 7C and 7D are graphs of changes in spectrum with respect to applied voltages of the liquid crystal element (cell thickness: 6 μm) without a chiral agent and the liquid crystal element (cell thickness: 6 μm) with the chiral agent added. FIGS. 7E and 7F are chromaticity diagrams of changes in chromaticity with respect to applied voltages of a liquid crystal element having a cell thickness of 3 μm and a liquid crystal element having a cell thickness of 4 μm to either of which a chiral agent is not added. FIG. 7G is a graph of applied voltage-transmittance characteristics of the liquid crystal element having the cell thickness of 6 μm without a chiral agent. FIG. 7H is a graph obtained by averaging the graph in FIG. 7G. FIG. 7I is a graph of applied voltage-transmittance characteristics of the liquid crystal element (cell thickness: 6 μm) with the chiral agent added. FIG. 7J is a graph obtained by averaging the graph in FIG. 7I. FIG. 7K is a graph of applied voltage-transmittance characteristics of the liquid crystal element having the cell thickness of 3 μm without a chiral agent. FIG. 7L is a graph obtained by averaging the graph in FIG. 7K. FIG. 7M is a graph of applied voltage-transmittance characteristics of the liquid crystal element having the cell thickness of 4 μm without a chiral agent. FIG. 7N is a graph obtained by averaging the graph in FIG. 7M. FIG. 7O is a graph collectively showing the graphs in FIGS. 7H, 7J, 7L, and 7N.

FIG. 8 is a diagram of a basic configuration of a homeotropic liquid crystal element serving as an object of a simulation.

FIG. 9A is a graph of retardation-transmittance characteristics. FIGS. 9B, 9C, and 9D are graphs of driving voltage-transmittance characteristics when the values of d/p are set to 0, 0.25, and 0.4.

FIGS. 10A, 10B, 10C, and 10D show colored states when the values of d/p are 0, 0.25, 0.325, and 0.4, respectively. FIGS. 10E, 10F, 10G, and 10H illustrate colored states when the values of d/p are 0, 0.25, 0.325, and 0.4, respectively.

FIGS. 11A to 11D are graphs of simulation results when the twist angle of the liquid crystal element is changed.

FIG. 12 is a schematic cross-sectional view of a liquid crystal element according to an embodiment.

FIG. 13 is a schematic cross-sectional view of an adaptive driving beam according to an embodiment.

FIG. 14 is a photograph showing an example of a projected image of the adaptive driving beam according to the embodiment.

FIG. 15 is a block diagram of a schematic configuration of an adaptive front-lighting system.

### DESCRIPTION OF THE PREFERRED EMBODIMENTS

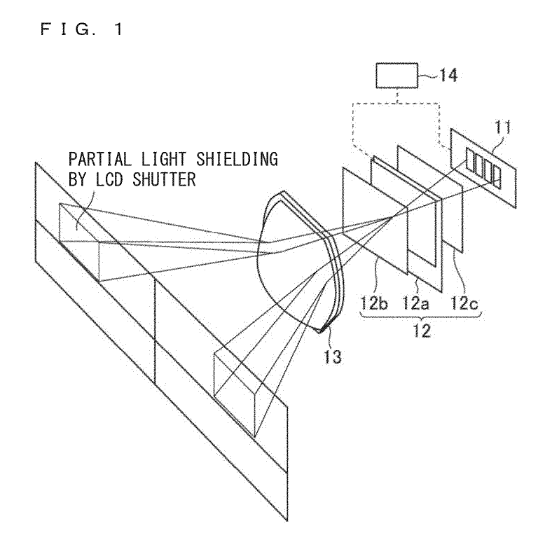

FIG. 1 illustrates a basic configuration of an adaptive driving beam (ADB) using a liquid crystal element.

A headlight illustrated in FIG. 1 includes (i) a light source 11 that emits, for example, white light, (ii) a dimming unit 12 arranged in an optical path of the light emitted from the light source 11 and having a dimming function, (iii) a lens (projector lens) 13 that projects the light emitted from the dimming unit 12, and (iv) a control device 14 that controls the light emission of the light source 11 and the dimming of the dimming unit 12.

The light source 11 uses, for example, a light-emitting diode (LED) element.

The dimming unit 12 includes, for example, a liquid crystal element (liquid crystal cell) 12a, and polarizing plates 12b and 12c arranged on a front substrate surface and a rear substrate surface of the liquid crystal element 12a in a cross nicol state. The liquid crystal element 12a is arranged near the focal point of the lens 13.

The liquid crystal element 12a includes a plurality of regions whose liquid-crystal-molecules array states can be individually changed. The control device 14 controls the transmittance, for example, light-transmission/light-shielding per region of the liquid crystal element 12a. The light emitted from the dimming unit 12 after the light-transmission/light-shielding regions are controlled is projected forward of the vehicle by the lens 13. Note that the headlight may further include an optical member (reflector (reflector plate), lens, etc.) that collects the light emitted from the light source 11, in a predetermined area of the liquid crystal element 12a.

The LED element is a semiconductor light-emitting element whose outgoing light spreads at a wide angle. In the headlight, even if an optical system is constituted by using a reflector and a lens to collect light on the liquid crystal element 12a at a narrow angle, light is typically incident on the liquid crystal element 12a at an angle of ±30° or more.

Owing to this, when a TN liquid crystal element is used as the liquid crystal element 12a, it is difficult to obtain good contrast.

In contrast, a homeotropic liquid crystal element has a high black level, thereby easily providing high contrast for a wide-angle optical system. However, if the retardation of a liquid crystal layer (Δn·d(Δn is a refractive-index anisotropy of a liquid crystal material, d is a cell thickness (the thickness of the liquid crystal layer)) increases, the transmitted light is likely colored yellow (electrically controlled birefringence (ECB) effect). When light is incident obliquely on the homeotropic liquid crystal element in the wide-angle optical system, the apparent cell thickness d increases, the retardation (Δn·d) increases, and the transmitted light is likely colored yellow. Particularly in the optical system of the headlight (wide-angle light-body optical system), for example, an area where light is most collected by the reflector and the lens (a center region of the liquid crystal element) is under the widest angle conditions. Due to this, illumination light in a front area is colored yellow and is noticeable.

The inventors of the subject application have diligently studied on a liquid crystal element that exhibits high quality (high performance), such as a high contrast ratio and yellowing prevention characteristics for transmitted light, for a wide-angle optical system. The high-quality liquid crystal element is preferably used for, for example, the adaptive driving beam having the basic configuration illustrated in FIG. 1.

A method of manufacturing a liquid crystal element (liquid crystal cell) used for characteristic evaluation is described. The manufacturing method described below is also applied to, for example, manufacturing of a liquid crystal element according to an embodiment.

A pair of transparent substrates, for example, glass substrates are prepared, and a transparent conductive film, for example, an indium tin oxide (ITO) film is formed on each of the transparent substrates. A forming method can be sputtering, vacuum evaporation, or another method. In this case, ITO-filmed glass substrates were used.

The ITO films are patterned to form a segment electrode (transparent electrode) on one of the pair of transparent substrates and to form a common electrode (transparent electrode) on the other of the pair of transparent substrates. In this case, a segment electrode in which an electrode is divided into a plurality of electrode regions (pixel regions) and a solid-pattern common electrode were used.

One substrate (segment substrate) on which the segment electrode is formed and the other substrate (common substrate) on which the common electrode is formed are used to constitute a liquid crystal element (to constitute a cell).

First, an alignment film that covers the electrode is formed on each of the segment substrate and the common substrate. The method of forming the alignment film can employ flexography, inkjet, or another method. In this case, a homeotropic alignment film (organic alignment film (polyimide)) of a type being excellent in printability and adhesion, and having rigid skeletons in side chains (for example, with mesomorphism) was patterned to a proper film thickness (for example, in a range from about 500 Å to about 800 Å) by flexography, and was thermally treated (for example, baked at a temperature in a range from 160° C. to 250° C. for 1 to 1.5 hours). Alternatively, an inorganic alignment film (whose main chain skeletons are formed by siloxane bonds (Si—O—Si bonds) may be used. After the thermal treatment, alignment is performed. In this case, rubbing was performed while a pushing depth was in a range from 0.3 mm to 0.8 mm. The rubbing direction was set such that pre-tilt angles of liquid crystal molecules are parallel to one another when the segment substrate and the common substrate are aligned with each other (anti-parallel alignment). Note that rubbing was performed in a direction at 45° with respect to a side of a rectangular liquid crystal element. The anti-parallel alignment is not essential.

Then, a sealing pattern was formed. For example, a sealing agent (epoxy, acryl, etc.) with high thermal resistance is used to form a main sealing pattern containing a gap control agent by a proper amount (for example, in a range from 2 wt % to 5 wt %) on one substrate (for example, segment substrate) by screen printing, dispenser printing, or the like. The diameter of the gap control agent was set, for example, such that the thickness of the liquid crystal layer was in a range from about 3 μm to about 6 μm. The thickness of the liquid crystal layer is not limited thereto. The gap control agent may be dispersed on the other substrate (for example, common substrate) or a rib member may be arranged to provide gap control. More specifically, for example, plastic balls with a particle size in a range from 3 μm to 6 μm may be diffused using a dry gap diffuser, or a column consisting of a rib member with a height in a range from 3 μm to 6 μm may be formed.

The segment substrate and the common substrate are aligned with each other such that the electrode formation surfaces face each other, and the main sealing agent is hardened by thermally treating the substrates or by irradiating the substrates with ultraviolet rays in a state where a constant pressure is applied to the substrates using a press machine or the like. In this case, a thermosetting sealing agent was used, and hardened at 150° C.

The gap between the segment substrate and the common substrate is filled with a liquid crystal material to form a liquid crystal layer. In this case, the liquid crystal material was injected by vacuum injection, and the gap was filled with a liquid crystal material with a negative dielectric-constant anisotropy Δε (refractive-index anisotropy Δn: 0.129). The liquid crystal material for filling is high-Tₙᵢ liquid crystal material containing liquid crystal molecules whose nematic phase-isotropic phase transition temperature (Tₙᵢ) is 130° C. or higher. Alternatively, the liquid crystal layer may be formed by one drop filling (ODF) and another liquid crystal material may be used. A chiral agent having capability of optical rotation was added to the liquid crystal material. A liquid crystal element filled with a liquid crystal material without a chiral agent was also fabricated.

After the liquid crystal material has been injected, an end sealing agent is applied to an injection port to seal the injection port. In this case, an ultraviolet-curable resin was used as the end sealing agent.

Thus, a homeotropic liquid crystal element (liquid crystal cell) was fabricated. Δn optically compensating plate such as a C-Plate may be arranged on one surface or both surfaces of the liquid crystal element.

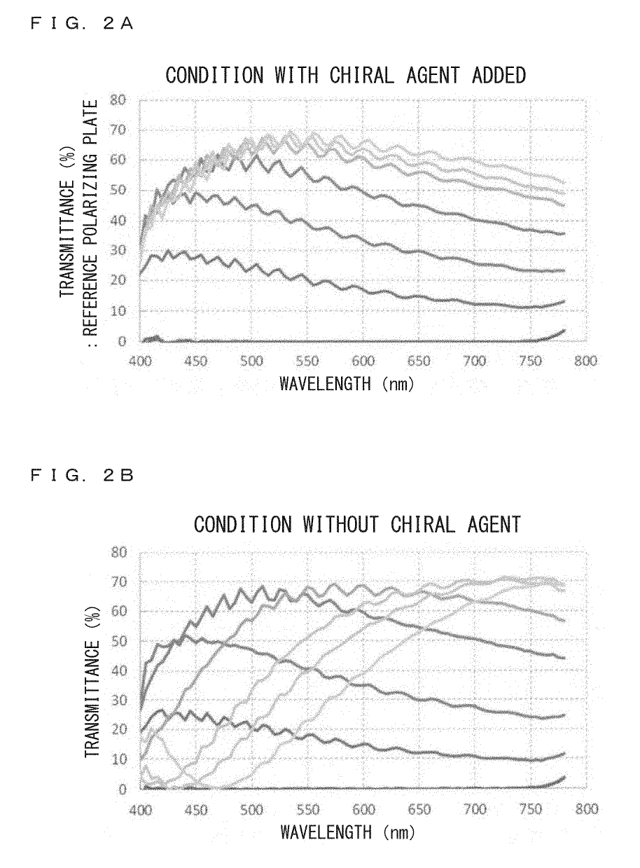

A first liquid crystal element characteristic evaluation is described with reference to FIGS. 2A to 5B. The first liquid crystal element characteristic evaluation was performed using a liquid crystal element fabricated by adding a chiral agent S-811 manufactured by Merck KGaA to a high-Tₙᵢ liquid crystal material (Tₙᵢ: 130° C. or higher, Δn: 0.129) such that d/p (d is cell thickness [μm], p is chiral pitch [μm]) be in a range from about 0.35 to about 0.4, and a liquid crystal element fabricated by not adding a chiral agent to a high-Tₙᵢ liquid crystal material (Tₙᵢ: 130° C. or higher, Δn: 0.129). The cell thickness of each liquid crystal element was 4.2 μm.

FIGS. 2A and 2B are graphs of changes in spectrum with respect to driving voltages of the liquid crystal element with the chiral agent added and the liquid crystal element without a chiral agent. The horizontal axis of the graph in each figure plots the wavelength in the unit “nm”, and the vertical axis plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed. The transmittance shown in both figures is a transmittance when the transmittance with one polarizing plate arranged is assumed as 100%. The liquid crystal element with the chiral agent added and the liquid crystal element without a chiral agent were driven by applying voltages with various voltage values and wavelength-transmittance characteristics were studied.

Referring to FIG. 2A, it is found that, in the liquid crystal element with the chiral agent added, the spectral shape less varies at any driving voltage and a white state is constantly obtained.

Referring to FIG. 2B, it is found that, in the liquid crystal element without a chiral agent, flatness of spectrum is degraded depending on the driving voltage. In particular, it is found that the transmitted light turns yellow at application of high voltage.

Next, the dependence on temperature was compared between the liquid crystal element with the chiral agent added and the liquid crystal element without a chiral agent.

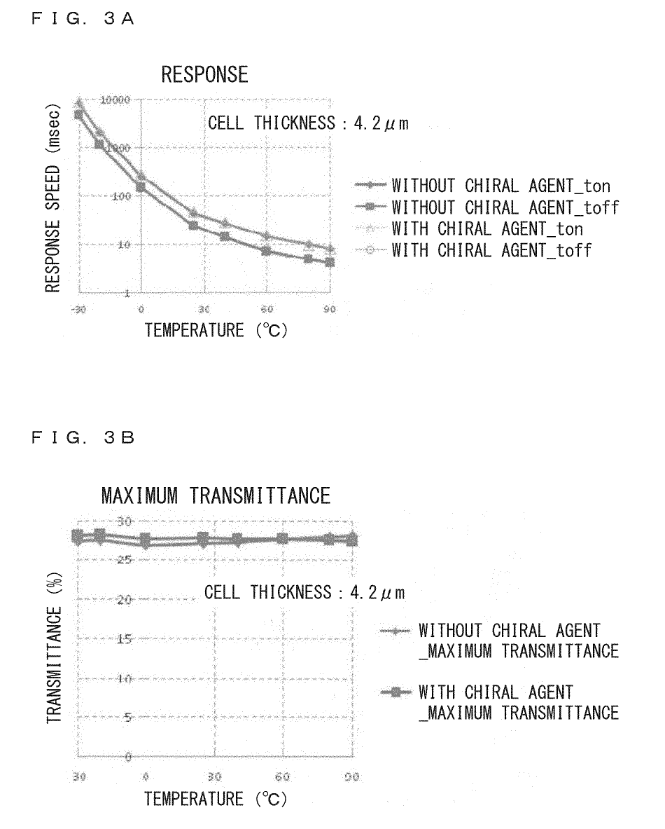

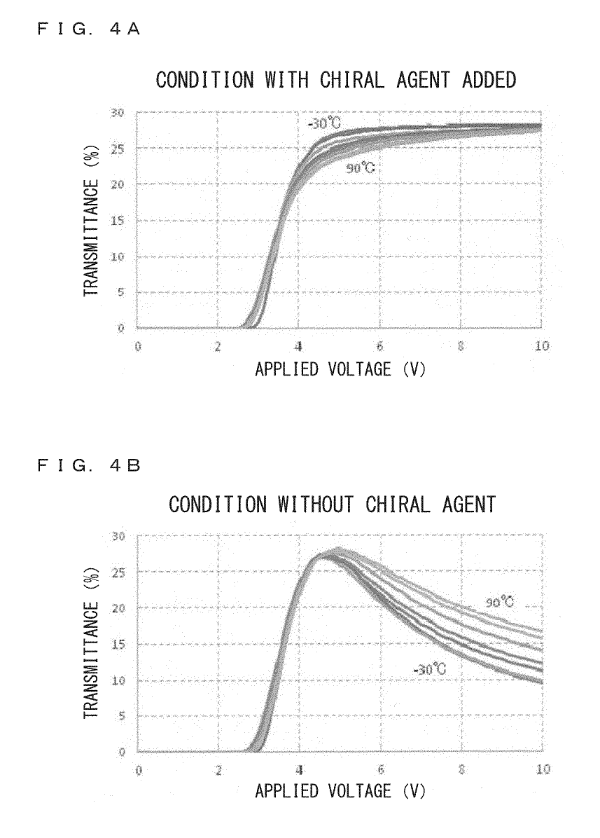

FIGS. 3A and 3B are graphs of changes in response (response speed) and changes in maximum transmittance with respect to changes in temperature of the liquid crystal element with the chiral agent added and the liquid crystal element without a chiral agent. The horizontal axis of the graph in each figure plots the temperature in the unit “° C.”. The vertical axis of the graph in FIG. 3A plots the response speed in the unit “msec”, and the vertical axis of the graph in FIG. 3B plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed. The transmittance shown in FIG. 3B is a transmittance when the transmittance through the air is assumed as 100%.

Referring to FIG. 3A, there is no noticeable difference in response between the liquid crystal element with the chiral agent added and the liquid crystal element without a chiral agent.

Referring to FIG. 3B, the liquid crystal element with the chiral agent added exhibits the maximum transmittance in a relatively wide temperature range.

FIGS. 4A and 4B are graphs of changes in applied voltage-transmittance characteristics with respect to changes in temperature of the liquid crystal element with the chiral agent added and the liquid crystal element without a chiral agent. The horizontal axis of the graph in each figure plots the applied voltage in the unit “V”, and the vertical axis plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed. The transmittance shown in both figures is a transmittance when the transmittance through the air is assumed as 100%.

Comparing the graphs in both figures, it is found that, in a temperature range from −30° C. to 90° C., the liquid crystal element without a chiral agent has high transmittances in a limited voltage range (the transmittance is the maximum in a voltage range in which voltages are 1.6 times to 1.8 times a threshold voltage and the transmittance decreases outside the voltage range), and the liquid crystal element with the chiral agent added has high transmittances in a wide voltage range (the transmittance is stably high in a voltage range in which voltages are about two times or more the threshold voltage). In addition, the liquid crystal element with the chiral agent added did not exhibit a change in color tone.

Regarding the liquid crystal element with the chiral agent added, a fine disclination line was observed in an initial state, and the disclination line was not eliminated even when a voltage was applied. However, by rubbing a surface of the liquid crystal cell (alignment correction), the elimination of the disclination line was recognized.

The applied voltage-transmittance characteristics before and after the elimination of the disclination line were studied.

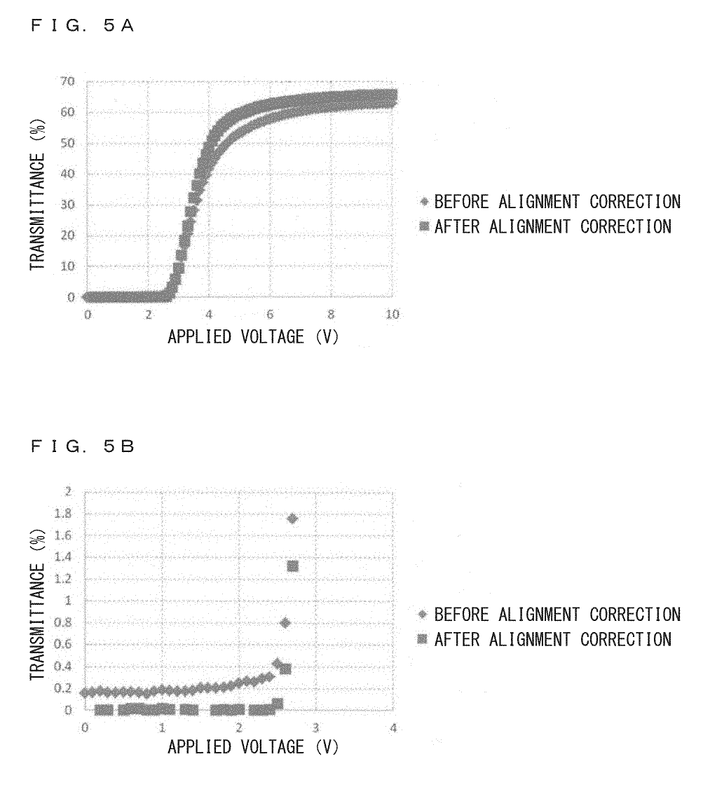

FIGS. 5A and 5B are graphs of applied voltage-transmittance characteristics before and after alignment correction of the liquid crystal element with the chiral agent added. The horizontal axis of the graph in each figure plots the applied voltage in the unit “V”, and the vertical axis plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed. The transmittance shown in both figures is a transmittance when the transmittance with one polarizing plate arranged is assumed as 100%. Note that the graph in FIG. 5B is a graph specifically showing part of the graph in FIG. 5A.

Referring to FIG. 5A, it is found that the threshold voltage decreases and the maximum transmittance increases by the alignment correction.

Referring to FIG. 5B, it is found that the off-level is improved (the transmittance at off-voltage application (at voltage non-application) decreases).

The liquid crystal element with the chiral agent added, the characteristics are shown in FIGS. 2A, 3A, 3B, and 4A, is a liquid crystal element on which the alignment correction has been performed.

Regarding the first liquid crystal element characteristic evaluation described with reference to FIGS. 2A to 5B, it is found that adding the chiral agent achieves high transmittance and provides transmitted light with high white level, the transmittance is high in a wide temperature range, the transmittance is high in a wide voltage range, and the white level is high at any voltage. The liquid crystal element with the chiral agent added had a problem in the initial alignment state; however, it is also found that the threshold voltage decreases and the maximum transmittance increases by the alignment correction, and the off-level is improved.

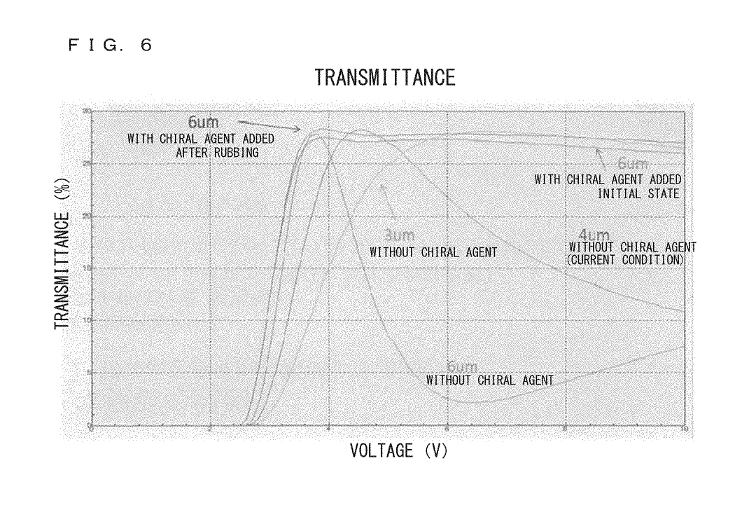

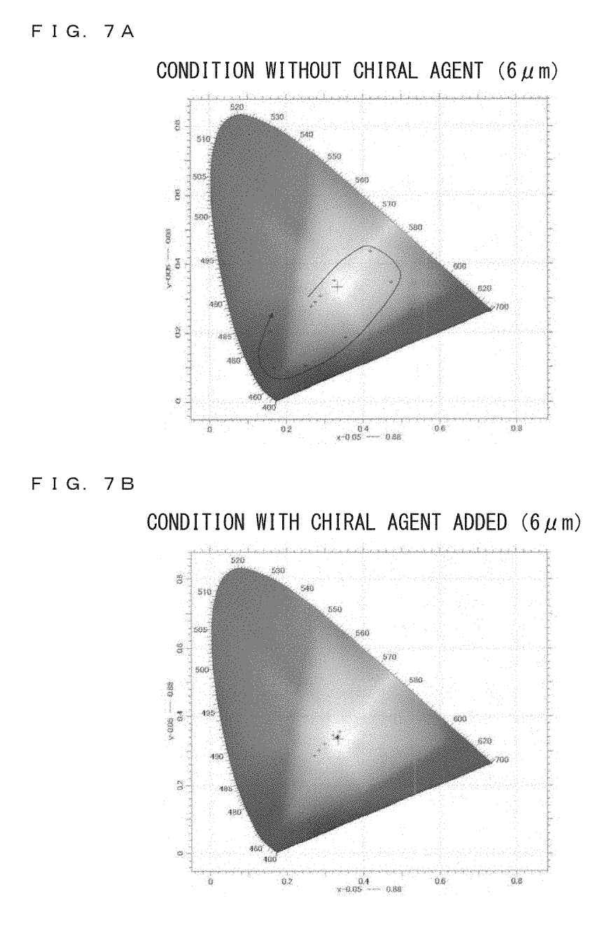

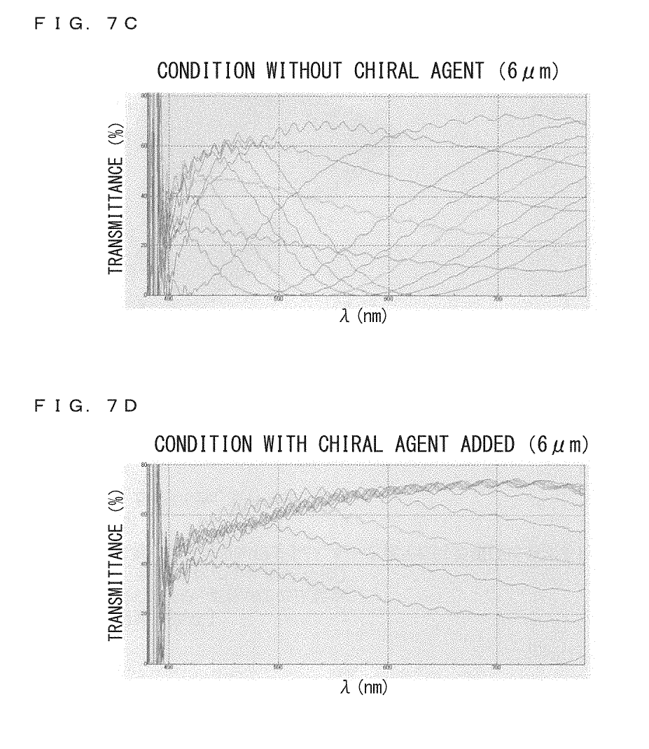

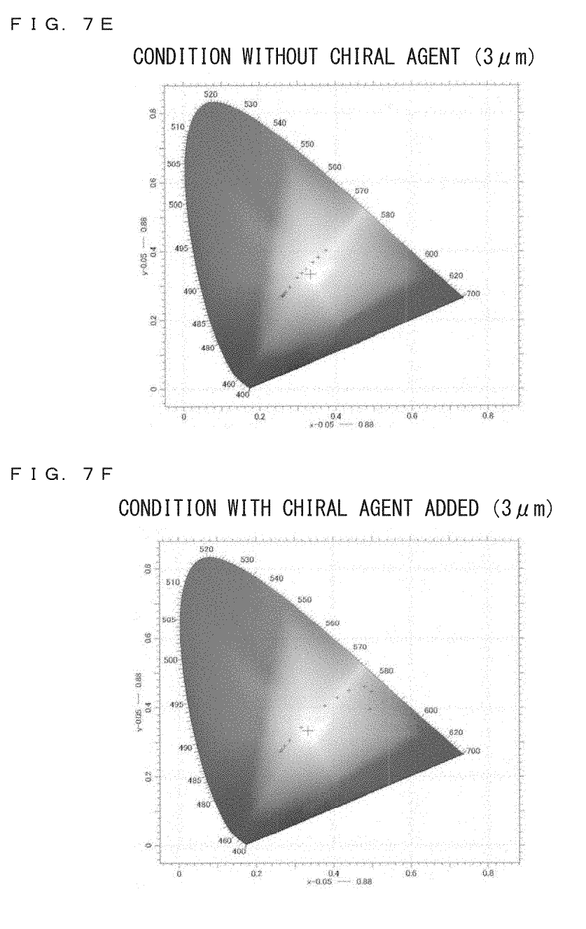

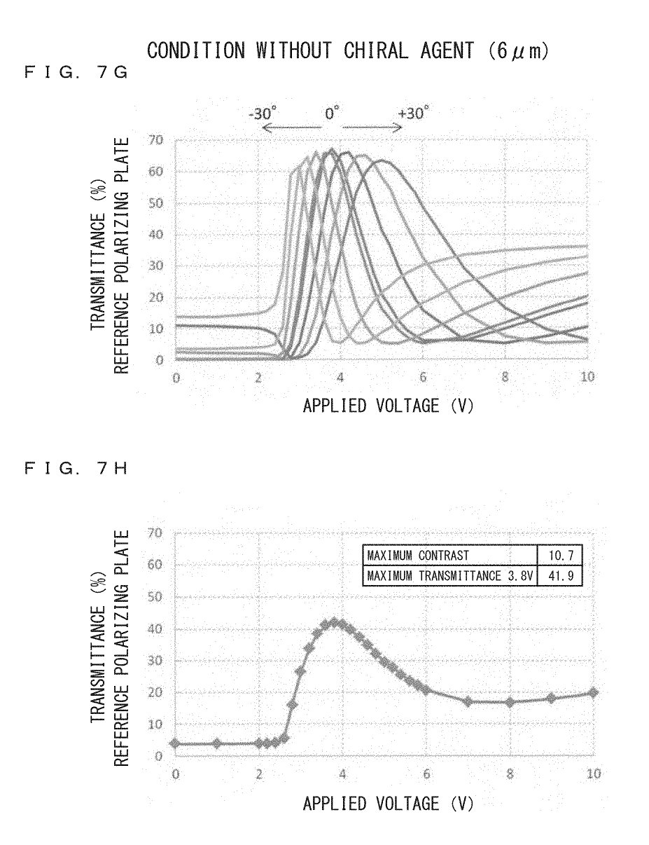

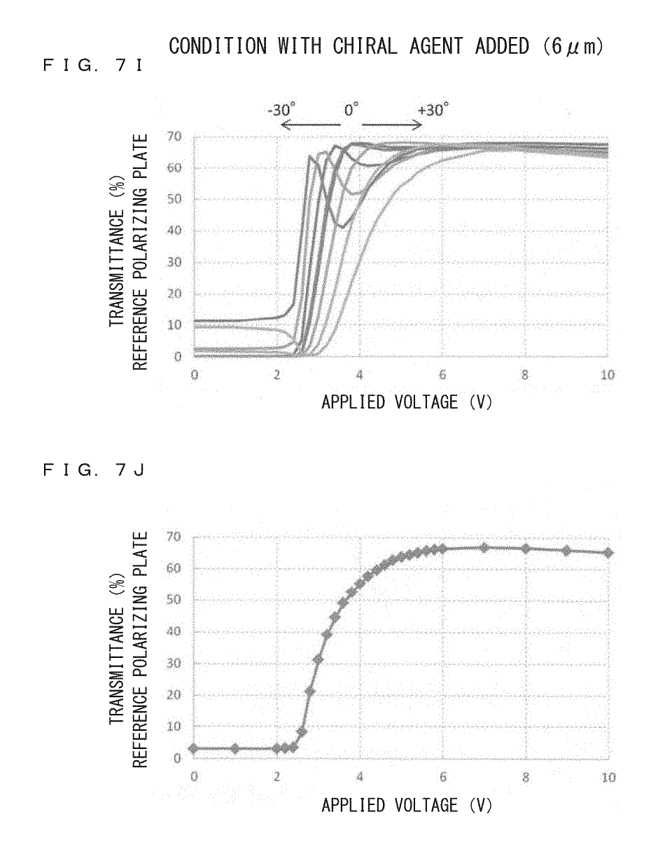

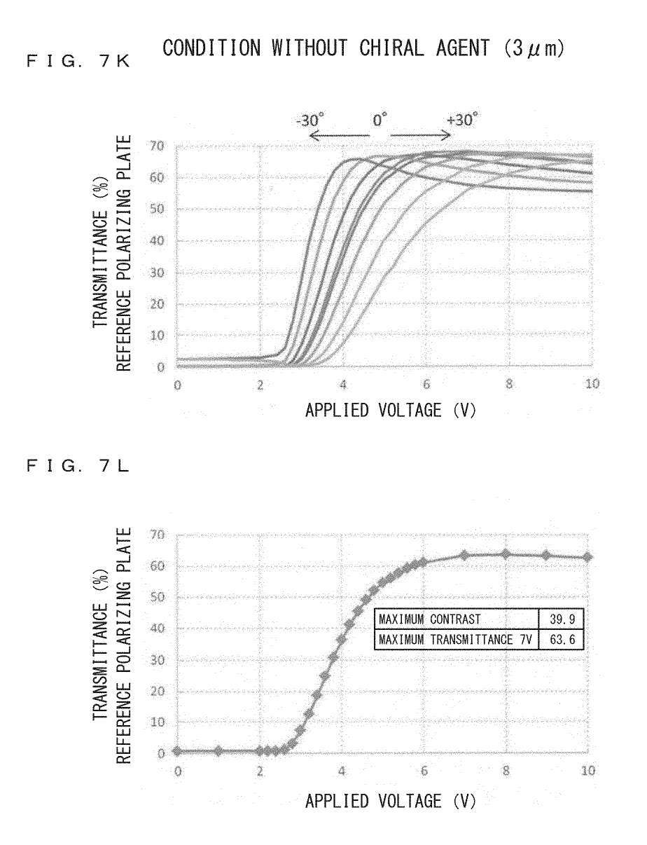

A second liquid crystal element characteristic evaluation is described with reference to FIGS. 6 to 7O. The second liquid crystal element characteristic evaluation was performed using a liquid crystal element fabricated by adding a chiral agent S-811 manufactured by Merck KGaA to a high Tₙᵢ liquid crystal material (Tₙᵢ: 130° C. or higher, Δn: 0.129) such that d/p be in a range from about 0.35 to about 0.4, and a liquid crystal element fabricated by not adding a chiral agent to a high Tₙᵢ liquid crystal material (Tₙᵢ: 130° C. or higher, Δn: 0.129). The cell thickness of the liquid crystal element with the chiral agent added was 6 μm. In the case without a chiral agent, a liquid crystal element having a cell thickness of 3 μm and a liquid crystal element having a cell thickness of 4 μm were fabricated in addition to a liquid crystal element having a cell thickness of 6 μm.

In the liquid crystal element with the chiral agent added having the cell thickness of 6 μm, similarly to the case with the cell thickness of 4.2 μm, a fine disclination line was observed in the initial state and was not eliminated although a voltage was applied. However, by rubbing a surface of the liquid crystal cell (alignment correction), the elimination of the disclination line was recognized.

FIG. 6 is a graph of applied voltage-transmittance characteristics of the fabricated liquid crystal elements. The horizontal axis of the graph plots the applied voltage in the unit “V”, and the vertical axis plots the transmittance in the unit “%”. Polarizing plates bonded to glass were arranged on both-surface sides of each liquid crystal element in a cross nicol state (the angle between the polarizing-axis direction and the rubbing direction: 45°) and measurement was performed. The transmittance shown in the figure is a transmittance when the transmittance through the air is assumed as 100%. The transmittance is that in the direction normal to the liquid crystal element (substrate normal direction). For the liquid crystal element with the chiral agent added, the applied voltage-transmittance characteristics before and after the rubbing (alignment correction) were shown.

With the measurement in the direction normal to the liquid crystal element, there is no difference in off-level (transmittance at off-voltage application (at voltage non-application)) due to the presence of the chiral agent and the difference in cell thickness. In addition, the maximum transmittances are substantially equivalent. In the liquid crystal element with the chiral agent added, the maximum transmittance increases by the rubbing (alignment correction).

Comparing the liquid crystal elements each having the cell thickness of 6 μm with each other, the liquid crystal element without a chiral agent has high transmittances in a limited voltage range, whereas the liquid crystal element with the chiral agent added has high transmittances in a wide voltage range.

FIGS. 7A and 7B are chromaticity diagrams of changes in chromaticity with respect to applied voltages of the liquid crystal element (cell thickness: 6 μm) without a chiral agent and the liquid crystal element (cell thickness: 6 μm) with the chiral agent added. In addition, FIGS. 7C and 7D are graphs of changes in spectrum (wavelength-transmittance characteristics measured by applying voltages with various voltage values) with respect to applied voltages of the liquid crystal element (cell thickness: 6 μm) without a chiral agent and the liquid crystal element (cell thickness: 6 μm) with the chiral agent added. The horizontal axis of the graph in each of FIGS. 7C and 7D plots the wavelength in the unit “nm”, and the vertical axis plots the transmittance in the unit “%”. Polarizing plates bonded to glass were arranged on both-surface sides of each liquid crystal element in a cross nicol state (the angle between the polarizing-axis direction and the rubbing direction: 45°) and measurement was performed. The transmittance shown in FIGS. 7C and 7D is a transmittance when the transmittance with one polarizing plate arranged is assumed as 100%.

FIGS. 7A and 7C show that, in the liquid crystal element (cell thickness: 6 μm) without a chiral agent, the chromaticity and spectrum are markedly changed and coloring occurs depending on the applied voltage.

FIGS. 7B and 7D show that, in the liquid crystal element (cell thickness: 6 μm) with the chiral agent added, the changes in the chromaticity and spectral shape depending on the applied voltage are small and a white state is constantly obtained in a region with a high applied voltage.

FIGS. 7E and 7F are chromaticity diagrams of changes in chromaticity with respect to applied voltages of the liquid crystal element having the cell thickness of 3 μm and the liquid crystal element having the cell thickness of 4 μm to either of which a chiral agent is not added.

FIG. 7E shows that, in the liquid crystal element having the cell thickness of 3 μm without a chiral agent, the change in chromaticity depending on the applied voltage is slight; however, yellowing appears as the applied voltage increases.

Referring to FIG. 7F, it is found that the liquid crystal element having the cell thickness of 4 μm without a chiral agent has a larger change in chromaticity depending on the applied voltage as compared with the liquid crystal element having the cell thickness of 3 μm without a chiral agent.

Note that FIGS. 7A, 7B, 7E, and 7F show the chromaticity in the direction normal to the liquid crystal element (substrate normal direction).

For example, color temperatures of projection light of headlights are determined in a range from 3500 K to 6000 K. Light on blue side is less possibly allowable but light on yellow side is allowable to a certain extent.

For example, to use the liquid crystal element fabricated under conditions without a chiral agent as the liquid crystal element 12a of the adaptive driving beam illustrated in FIG. 1, the liquid crystal element having the cell thickness of 3 μm emits projection light just within the allowable range. The liquid crystal element having the cell thickness (4 μm, 6 μm) larger than 3 μm emits projection light at a color temperature lower than 3500 K. Even with the liquid crystal element having the cell thickness of 3 μm, since light incident in an oblique direction tends to turn yellow, projection light whose color temperature is lower than 3500 K may be emitted when the applied voltage increases.

In contrast, the outgoing light of the liquid crystal element (cell thickness: 6 μm) fabricated by adding the chiral agent is stable at color temperatures around 6000 K, and hence is suitably used for, for example, the illumination light of the adaptive driving beam.

FIGS. 7G to 7O show transmittances in a direction in which the viewing-angle dependence is the maximum (in the direction at 45° with respect to the polarizing-axis direction).

FIG. 7G is a graph of applied voltage-transmittance characteristics of the liquid crystal element with the cell thickness of 6 μm without a chiral agent. The horizontal axis of the graph plots the applied voltage in the unit “V”, and the vertical axis plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed such that the viewing-angle direction is inclined in a range from −30° to +30° in the polar-angle direction with respect to the direction normal to the liquid crystal element (substrate normal direction), in the azimuth-angle direction with the maximum viewing-angle dependence (the direction at 45° with respect to the polarizing-axis direction). Note that the transmittance is a transmittance when the transmittance with one polarizing plate arranged is assumed as 100%. FIG. 7H is a graph obtained by averaging the graph in FIG. 7G.

Referring to FIG. 7G, it is found that the applied voltage-transmittance characteristics vary depending on the viewing angle.

Referring to FIG. 7H, it is found that, when the viewing-angle direction is inclined, both the contrast and the maximum transmittance decrease.

FIG. 7I is a graph of applied voltage-transmittance characteristics of the liquid crystal element (cell thickness: 6 μm) with the chiral agent added. The horizontal axis of the graph plots the applied voltage in the unit “V”, and the vertical axis plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed such that the viewing-angle direction is inclined in a range from −30° to +30° in the polar-angle direction with respect to the direction normal to the liquid crystal element (substrate normal direction), in the azimuth-angle direction with the maximum viewing-angle dependence (the direction at 45° with respect to the polarizing-axis direction). Note that the transmittance is a transmittance when the transmittance with one polarizing plate arranged is assumed as 100%. FIG. 7J is a graph obtained by averaging the graph in FIG. 7I.

Referring to FIG. 7I, it is found that the variation in the applied voltage-transmittance characteristics depending on the viewing angle is less than that of the liquid crystal element having the cell thickness of 6 μm without a chiral agent (see FIG. 7G).

Referring to FIG. 7J, it is found that the maximum transmittance can increase also in the inclined viewing-angle direction under a high-voltage driving condition. Since light leakage occurs depending on the viewing angle at off-voltage application (at voltage non-application), the contrast decreases. Still, the decrease in contrast depending on the viewing angle is less than that of a typical homeotropic liquid crystal element.

FIG. 7K is a graph of applied voltage-transmittance characteristics of a liquid crystal element having a cell thickness of 3 μm without a chiral agent. The horizontal axis of the graph plots the applied voltage in the unit “V”, and the vertical axis plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed such that the viewing-angle direction is inclined in a range from −30° to +30° in the polar-angle direction with respect to the direction normal to the liquid crystal element (substrate normal direction), in the azimuth-angle direction with the maximum viewing-angle dependence (the direction at 45° with respect to the polarizing-axis direction). Note that the transmittance is a transmittance when the transmittance with one polarizing plate arranged is assumed as 100%. FIG. 7L is a graph obtained by averaging the graph in FIG. 7K.

Referring to FIG. 7K, it is found that the variation in the applied voltage-transmittance characteristics depending on the viewing angle in the liquid crystal element having the cell thickness of 3 μm without a chiral agent is less than that of the liquid crystal element having the cell thickness of 6 μm without a chiral agent (see FIG. 7G).

Referring to FIG. 7L, the maximum transmittance can increase also in the inclined viewing-angle direction under a high-voltage driving condition. However, it is found that the maximum transmittance in this case is lower than the maximum transmittance of the liquid crystal element having the cell thickness of 6 μm with the chiral agent added (see FIG. 7J). Note that, in the liquid crystal element having the cell thickness of 3 μm without a chiral agent, light leakage depending on the viewing angle at off-voltage application (at voltage non-application) less likely occurs, and the contrast is higher than that under the other conditions.

FIG. 7M is a graph of applied voltage-transmittance characteristics of a liquid crystal element having a cell thickness of 4 μm without a chiral agent. The horizontal axis of the graph plots the applied voltage in the unit “V”, and the vertical axis plots the transmittance in the unit “%”. Polarizing plates bonded to glass were arranged on both-surface sides of the liquid crystal element in a cross nicol state (the angle between the polarizing-axis direction and the rubbing direction: 45°) and measurement was performed such that the viewing-angle direction is inclined in a range from −30° to +30° in the polar-angle direction with respect to the direction normal to the liquid crystal element (substrate normal direction), in the azimuth-angle direction with the maximum viewing-angle dependence (the direction at 45° with respect to the polarizing-axis direction). Note that the transmittance is a transmittance when the transmittance with one polarizing plate arranged is assumed as 100%. FIG. 7N is a graph obtained by averaging the graph in FIG. 7M.

Referring to FIG. 7M, it is found that the variation in the applied voltage-transmittance characteristics depending on the viewing angle in the liquid crystal element having the cell thickness of 4 μm without a chiral agent is more than that of the liquid crystal element having the cell thickness of 3 μm without a chiral agent (see FIG. 7K).

Referring to FIG. 7N, it is found that, when the viewing-angle direction is inclined, the maximum transmittance decreases. The contrast is relatively high.

FIG. 7O collectively shows the graphs in FIGS. 7H, 7J, 7L, and 7N. The liquid crystal element (cell thickness: 6 μm) with the chiral agent added has the maximum transmittance when the viewing angle is changed in the direction with the maximum viewing-angle dependence (the direction at 45° with respect to the polarizing-axis direction), and has high transmittances in a wide voltage range.

The second liquid crystal element characteristic evaluation described with reference to FIGS. 6 to 7O revealed that the liquid crystal elements with the chiral agent added obtains a stable white state, has high transmittances even in an inclined viewing-angle direction, and has high transmittances in a wide voltage range. When the twisting angle of the liquid crystal layer of the liquid crystal element at voltage application was measured, the twisting angle was in a range from 70° to 120°, and thus it was recognized that high transmittances can be held in a wide voltage range when the twisting angle is in this range.

A third liquid crystal element characteristic evaluation is described with reference to FIGS. 8 to 11D. The third liquid crystal element characteristic evaluation was performed by simulation analysis. The simulation analysis used LCD Master 1D analysis software manufactured by Shintech, Inc.

FIG. 8 illustrates a basic configuration of a homeotropic liquid crystal element serving as an object of a simulation. A cellulose triacetate (TAC) film and a polarizing plate were arranged on the front side of a liquid crystal layer using a liquid crystal material with a negative dielectric-constant anisotropy Δε and having a pre-tilt angle of 89.5°, and a viewing-angle compensating plate (cyclo-olefin polymer (COP) film) and a polarizing plate were arranged on the back side of the liquid crystal layer. The polarizing plates used SHC13U manufactured by Polatechno Co., Ltd., and were arranged in a cross nicol state.

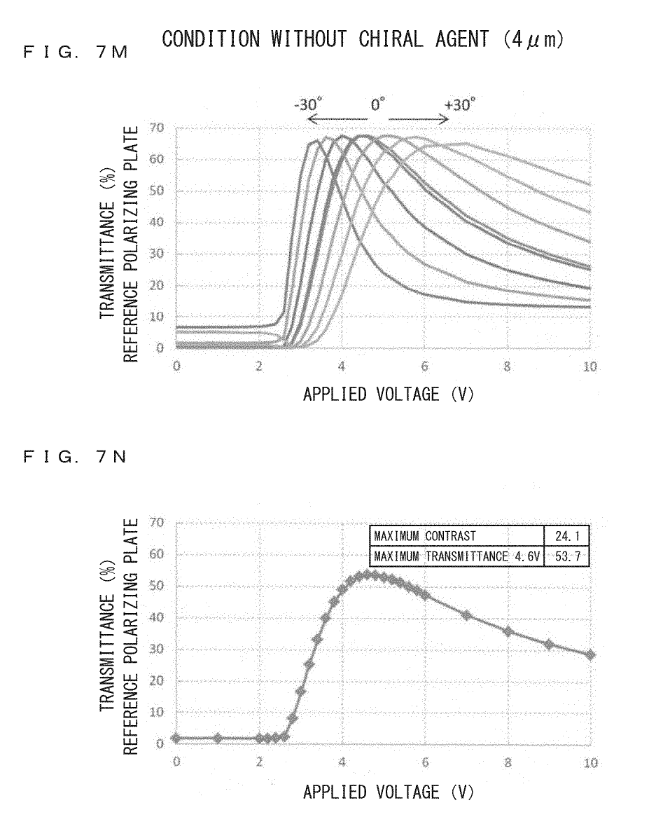

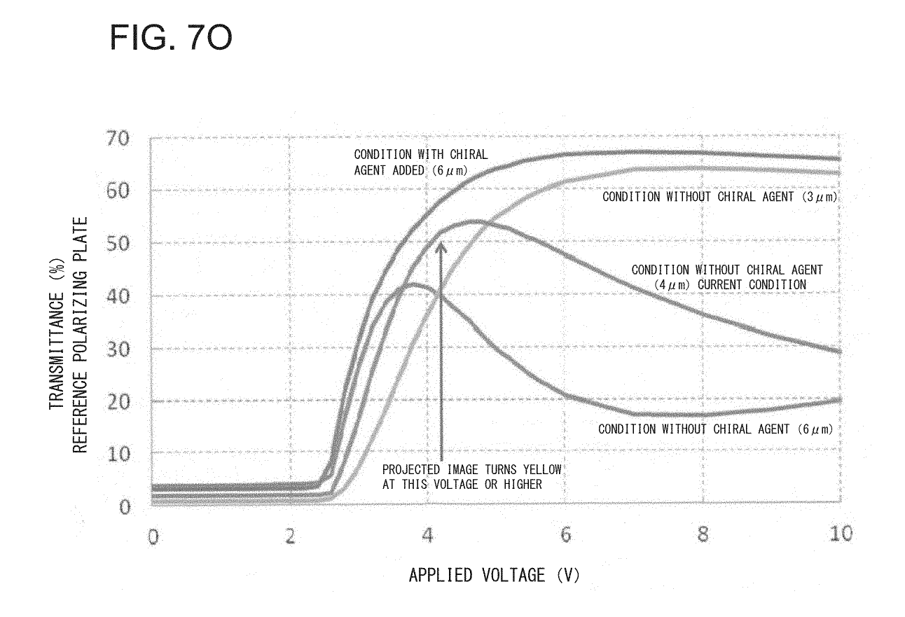

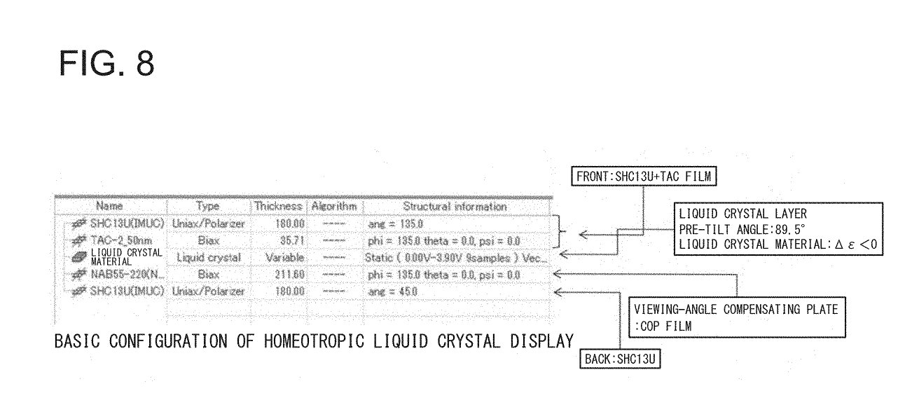

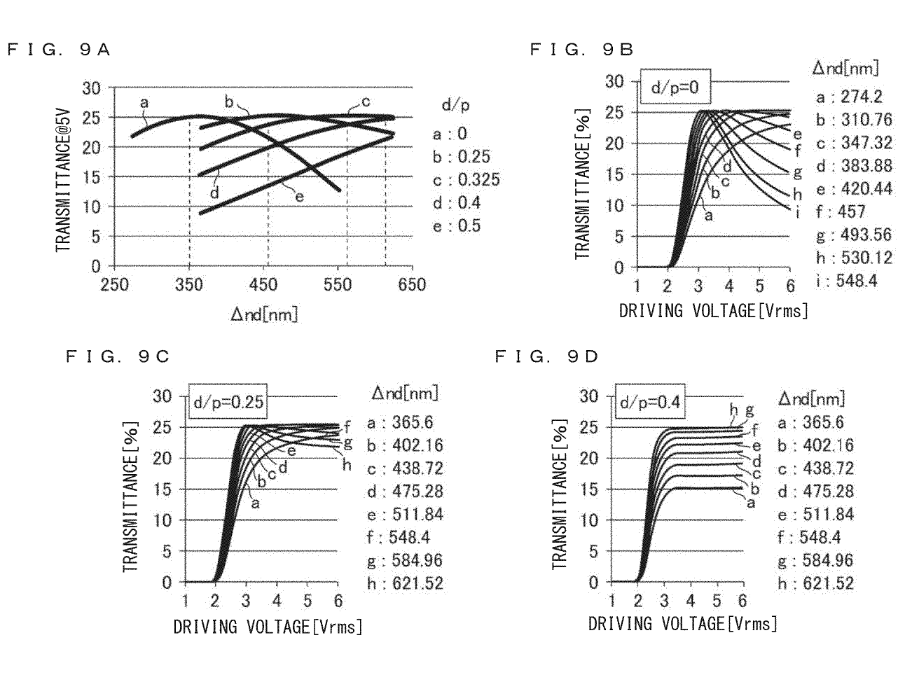

FIGS. 9A to 10H are graphs showing simulation results when a liquid crystal element is in an anti-parallel alignment (the angle between the polarizing-axis direction and the alignment direction: 45°), and when d/p setting is changed by adding a right-twist chiral agent to the liquid crystal layer while the anti-parallel alignment is held.

FIG. 9A shows retardation-transmittance characteristics. The horizontal axis of the graph plots the retardation of the liquid crystal layer in the unit “nm”, and the vertical axis plots the transmittance at voltage application of 5 V in the unit “%”. Curves a, b, c, d, and e show retardation-transmittance characteristics when values of d/p are 0, 0.25, 0.325, 0.4, and 0.5, respectively. The transmittance is a transmittance when the transmittance through the air is assumed as 100%.

It is found that the retardation at which the transmittance is the maximum at voltage application of 5 V increases as d/p increases. In addition, it is found that the liquid crystal elements having d/p of 0.25, 0.325, and 0.4 (0.25 d/p 0.4) have high transmittances and exhibit small changes in transmittance with respect to changes in retardation (yellowing less likely occurs). The value d/p is preferably in a range from 0.25 to 0.4.

FIGS. 9B, 9C, and 9D show driving voltage-transmittance characteristics when the values of d/p are set to 0, 0.25, and 0.4. The horizontal axis of the graph plots the driving voltage in the unit “Vrms”, and the vertical axis plots the transmittance in the unit “%”. The driving voltage-transmittance characteristics were analyzed with a plurality of retardations. The transmittance is a transmittance when the transmittance through the air is assumed as 100%.

When the value of d/p is 0, the driving voltage-transmittance characteristics exhibit a steep convex curve. As the value of d/p increases, a transmittance saturation effect appears at a high voltage.

FIGS. 10A to 10H show colored states of transmitted light. FIGS. 10A (10E), 10B (10F), 10C (10G), and 10D (10H) show colored states when the values of d/p are 0, 0.25, 0.325, and 0.4, respectively. FIGS. 10E to 10H express the colored states of FIGS. 10A to 10D in text of three colors “blue”, “white”, and “yellow”.

Regarding the liquid crystal element whose d/p is 0, yellowing noticeably appears in a bright state as the driving voltage value increases in the case of the same retardation and as the retardation increases in the case of the same driving voltage value.

When d/p is in a range from 0.25 to 0.4, increasing d/p increases the retardation under the optimal conditions; however, yellowing is less likely observed even at high-voltage application. The possible reason is that twisted alignment at voltage application reduces wavelength dispersion of refractive index.

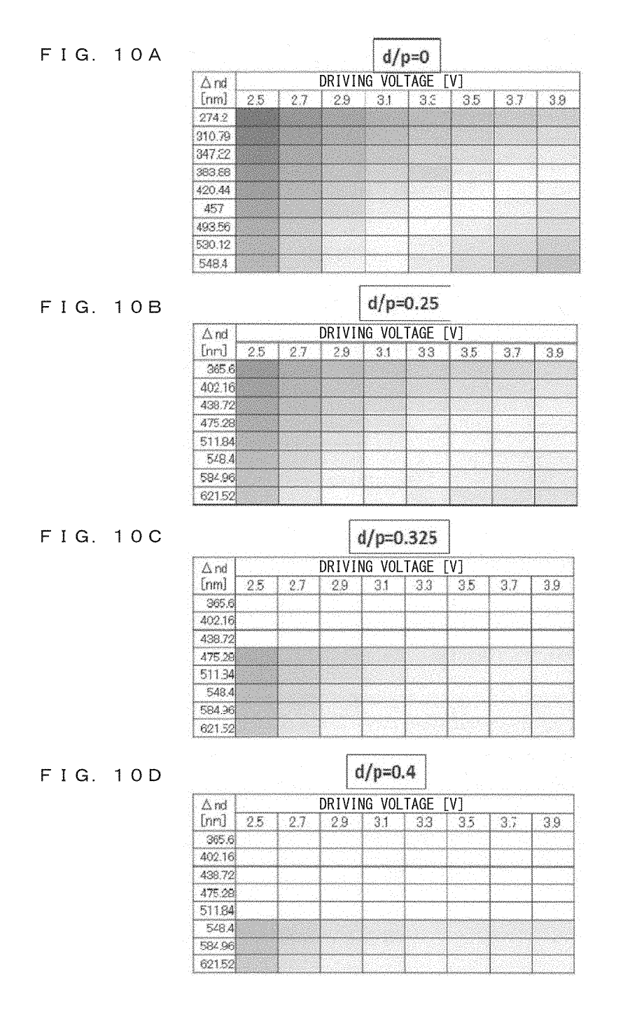

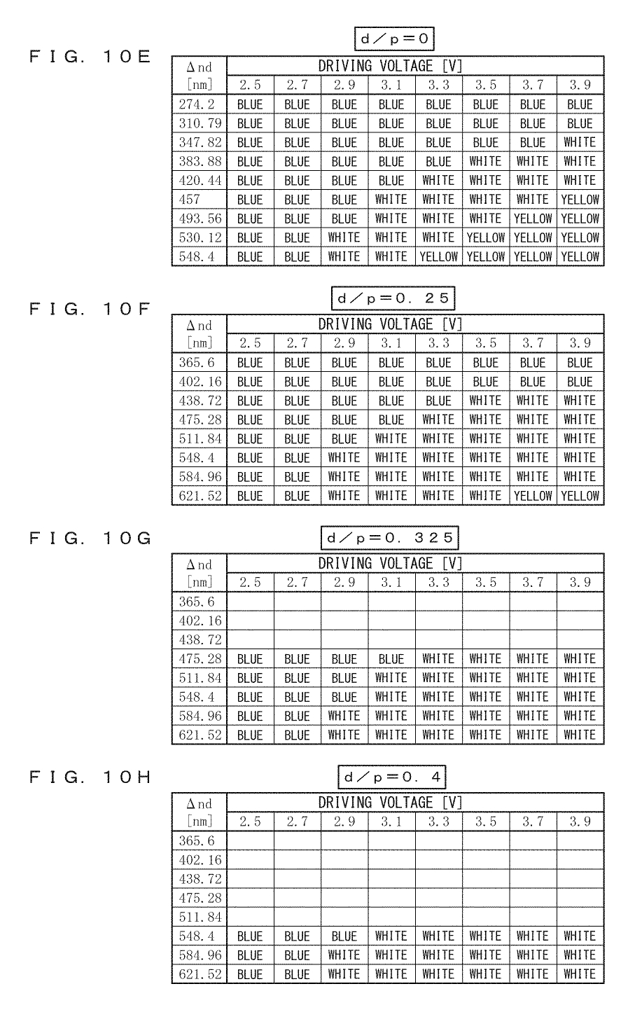

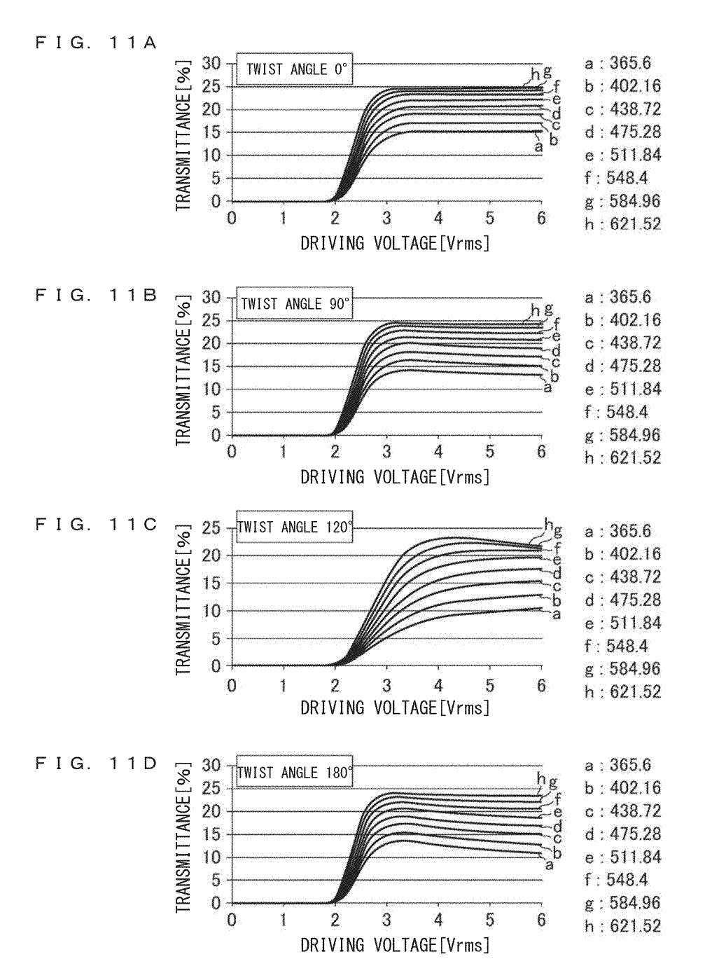

FIGS. 11A to 11D show simulation results when the twist angle of a liquid crystal element is changed. In the simulation, the twist angle was changed by changing the rubbing direction while d/p was fixed at 0.4.

FIGS. 11A, 11B, 11C, and 11D are graphs showing driving voltage-transmittance characteristics when the twist angles are respectively 0° (anti-parallel alignment), 90°, 120°, and 180°. The horizontal axis of the graph plots the driving voltage in the unit “Vrms”, and the vertical axis plots the transmittance in the unit “%”. The driving voltage-transmittance characteristics were analyzed with a plurality of retardations. The transmittance is a transmittance when the transmittance through the air is assumed as 100%.

When the twist angle is 120°, a phenomenon in which steepness of electro-optical characteristics decreases is recognized, and the shape of the driving voltage-transmittance curve obviously differs from that under the other twist angle conditions.

When the twist angles are 0°, 90°, and 180°, driving voltage-transmittance curves of similar shapes are obtained. It is found that, when the twist angle is 0°, the maximum transmittance is obtained with the least retardation. The twist angle is most preferably 0° (anti-parallel alignment) and is preferable in the order of 90° and 180°.

The third liquid crystal element characteristic evaluation described with reference to FIGS. 8 to 11D revealed that the liquid crystal elements whose d/p are in the range from 0.25 to 0.4 have high transmittances and advantageously have less changes in transmittance with respect to changes in retardation (yellowing less likely occurs); and under such conditions, although the retardation under the optimal conditions increases as d/p increases, yellowing is less likely observed even at high-voltage application; and the anti-parallel alignment is the most preferable, and the twist angles of 90° and 180° are also preferable.

The first liquid crystal element characteristic evaluation used the liquid crystal element fabricated by adding the chiral agent and having the cell thickness of 4.2 μm (the refractive-index anisotropy Δn of the liquid crystal material: 0.129). The retardation of the liquid crystal layer of this liquid crystal element is 541.8 nm. The second liquid crystal element characteristic evaluation also used the liquid crystal element fabricated by adding the chiral agent and having the cell thickness of 6 μm (the refractive-index anisotropy Δn of the liquid crystal material: 0.129). The retardation of the liquid crystal layer of this liquid crystal element is 774 nm.

The inventors of the subject application have found that, for example, the retardation of a liquid crystal layer is preferably 510 nm or more, and a higher transmittance is achievable particularly when the retardation is 620 nm or more. However, if the retardation is too large, the response speed of the liquid crystal layer (liquid crystal molecules) decreases, and hence the upper limit of the retardation is preferably about 800 nm.

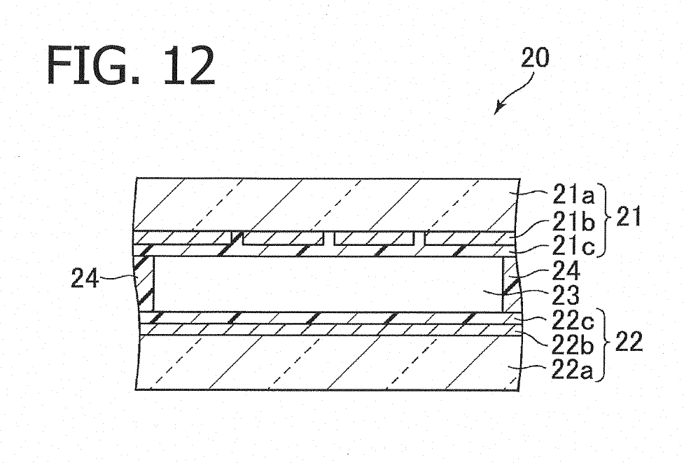

FIG. 12 is a schematic cross-sectional view of a liquid crystal element (a homeotropic liquid crystal element 20) according to an embodiment.

The liquid crystal element 20 according to the embodiment includes an upper substrate 21 and a lower substrate 22 that are arranged substantially in parallel to each other to face each other, and a liquid crystal layer 23 arranged between both the substrates 21 and 22.

The upper substrate 21 includes an upper transparent substrate 21a, an upper transparent electrode 21b arranged on the upper transparent substrate 21a, and an upper alignment film 21c arranged on the upper transparent substrate 21a to cover the upper transparent electrode 21b. Likewise, the lower substrate 22 includes a lower transparent substrate 22a, a lower transparent electrode 22b arranged on the lower transparent substrate 22a, and a lower alignment film 22c arranged on the lower transparent substrate 22a to cover the lower transparent electrode 22b. The upper and lower transparent substrates 21a and 22a are, for example, glass substrates. The upper and lower transparent electrodes 21b and 22b are formed of, for example, ITO. The upper transparent electrode 21b has a plurality of electrode regions electrically isolated from one another. The lower transparent electrode 22b is a solid-pattern electrode. The upper and lower alignment films 21c and 22c are, for example, homeotropic alignment films formed of polyimide and are rubbed in mutually opposite directions. Thus, anti-parallel alignment of the liquid crystal layer 23 is achieved.

The liquid crystal layer 23 is formed of a liquid crystal material having a negative dielectric-constant anisotropy 4E, and arranged in an inside region of a sealing part 24 between the upper and lower substrates 21 and 22. The retardation of the liquid crystal layer 23 is 510 nm or more and 800 nm or less, and is more preferably 620 nm or more and 800 nm or less. In addition, a chiral agent is added to the liquid crystal layer 23 such that d/p is 0.25 or more and 0.4 or less. The liquid crystal layer 23 is a homeotropic liquid crystal layer in which the liquid crystal molecules are substantially vertically aligned with respect to the upper and lower substrates 21 and 22 (the upper and lower transparent substrates 21a and 22a) when off-voltage is applied between the upper and lower transparent electrodes 21b and 22b (at voltage non-application). When off-voltage is applied (at voltage non-application), the twist angle is 0°; however, the twisting power by the chiral agent changes the alignment state of the liquid crystal molecules such that the twist angle increases as the applied voltage increases. The twist angle increases to a range from 120° to 150° at maximum.

Alternatively, instead of the anti-parallel alignment (twist angle: 0°), rubbing may be performed such that the twist angle is 90° or 180°.

The liquid crystal element 20 according to the embodiment has, for example, a rectangular shape in plan view. A pixel is defined in an overlap region in plan view between each of the plurality of electrode regions electrically isolated from one another of the upper transparent electrode 21b and the lower transparent electrode 22b. The pixel has, for example, a square shape. Pixels are arranged in rows and columns along the sides of the rectangle of the liquid crystal element 20. Note that the rubbing direction is a direction at 45° with respect to a side of the rectangular liquid crystal element 20.

In the liquid crystal element 20 according to the embodiment, by applying voltage between the upper and lower transparent electrodes 21b and 22b (between each of the plurality of electrode regions electrically isolated from one another of the upper transparent electrode 21b and the lower transparent electrode 22b), the alignment state of the liquid crystal molecules can be changed on a pixel basis; and the transmittance, for example, light-transmission/light-shielding can be controlled on a pixel basis. The liquid crystal element 20 according to the embodiment is, for example, statically driven.

The liquid crystal element 20 according to the embodiment can provide, for example, a high transmittance and transmitted light with a high white level (coloring such as yellowing is suppressed). The transmittance and white level are high even in an inclined viewing-angle direction. Further, the decrease in contrast depending on the viewing angle is less than that of a typical homeotropic liquid crystal element. The liquid crystal layer 23 (liquid crystal molecules) has a fast response speed. The liquid crystal element 20 according to the embodiment is a high-quality liquid crystal element.

Since such characteristics are provided (effects are attained), the liquid crystal element 20 according to the embodiment can be suitably used for, for example, a wide-angle light-body optical system.

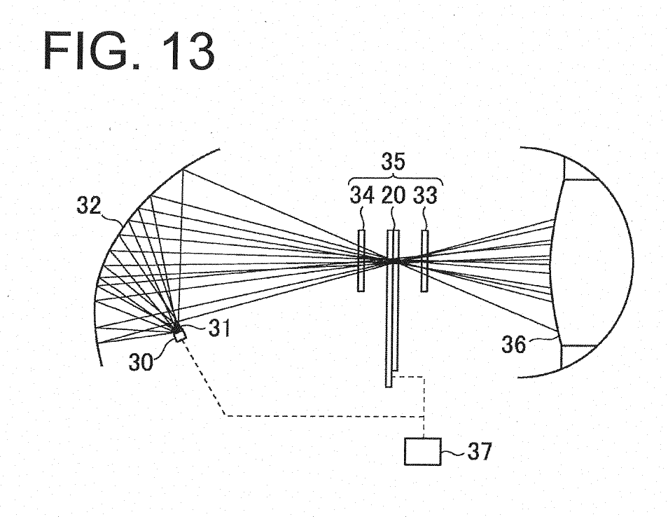

FIG. 13 is a schematic cross-sectional view of an illumination device (adaptive driving beam) according to an embodiment.

The adaptive driving beam according to the embodiment includes a light source 30, a separator 31, a reflector 32, a liquid crystal element 20, polarizing plates 33 and 34, a lens (projector lens) 36, and a control device 37. The liquid crystal element 20 is the liquid crystal element 20 according to the above-described embodiment. The liquid crystal element 20, and the polarizing plates 33 and 34 arranged on a front substrate surface and a rear substrate surface of the liquid crystal element 20 in a cross nicol state constitute a dimming unit 35. The liquid crystal element 20 is arranged near the focal point of the lens 36. More specifically, an electrode pattern part of the liquid crystal element 20 is arranged at the focal point of the lens 36. The control device 37 controls, for example, the light emission of the light source 30 and the dimming of the dimming unit 35.

The light source 30 includes, for example, multiple LED elements arranged in an array that emit white light under the control of the control device 37. The white light emitted from the light source 30 spreads once, is reflected by the separator 31 and the reflector 32 arranged in the optical path of the light emitted from the light source 30, and is collected at the dimming unit 35 (the liquid crystal element 20) having a dimming function. The light is incident on the liquid crystal element 20 in a direction inclined, for example, by 30° or more with respect to the direction normal to the liquid crystal element 20 (substrate normal direction).

The control device 37 applies a voltage between the upper and lower electrodes of the liquid crystal element 20, and controls the transmittance, for example, light-transmission/light-shielding per pixel.

The light whose light-transmission/light-shielding has been controlled per pixel is emitted from the dimming unit 35, is incident on the lens 36 while spreading again, and is projected forward of the vehicle by the lens 36 in the form of distributed light which is partly shielded.

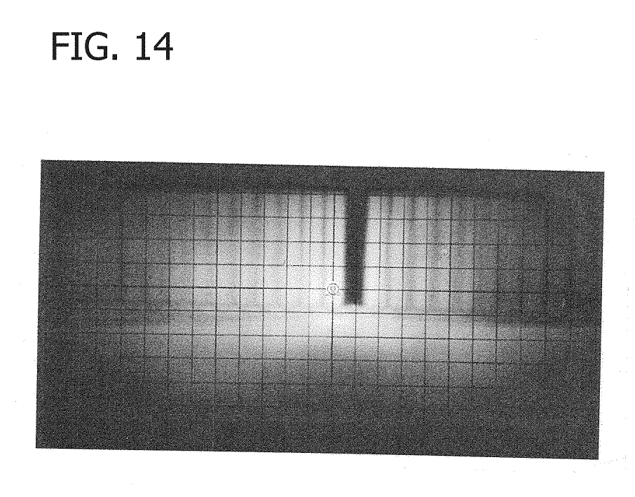

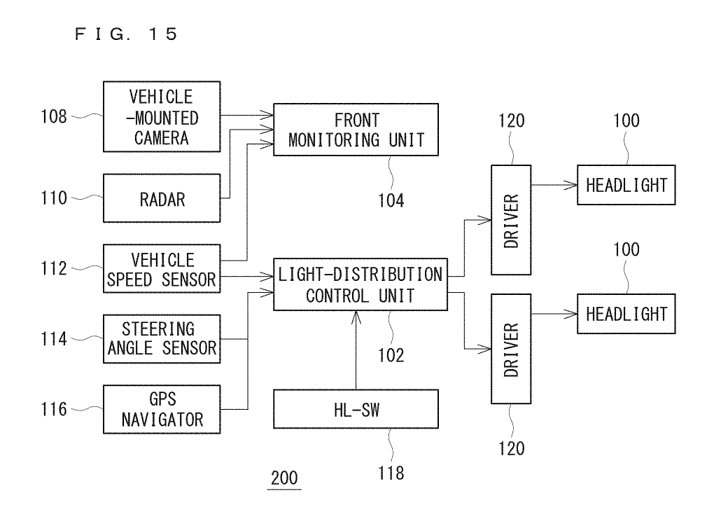

FIG. 14 shows an example of a projected image of an adaptive driving beam according to the embodiment (high beams are expected). Δn area around the center that seems to lack a pattern is a region where the light is shielded by a shutter function of the dimming unit 35 (the liquid crystal element 20). The other area appearing white is a region where the transmitted light through the liquid crystal element 20 is projected.

The dimming unit 35 of the adaptive driving beam according to the embodiment uses the liquid crystal element 20 according to the embodiment. Thus, the dimming unit 35 has a high transmittance. Distributed light with a high white level (coloring to yellow or another color being suppressed) is projected forward of the vehicle. The light incident on the liquid crystal element 20 in the inclined incident direction also has high transmittance and high white level. Further, light distribution with high contrast is provided. The adaptive driving beam according to the embodiment is a high-quality illumination device.

As the liquid crystal element 12a whose basic configuration is illustrated in FIG. 1, the liquid crystal element 20 according to the embodiment may be used.

FIG. 15 is a block diagram of a schematic configuration of an adaptive front-lighting system. A front-lighting system 200 includes left and right vehicular headlights 100, a light-distribution control unit 102, and a front monitoring unit 104. The vehicular headlights 100 each include a light source including an LED element array in which multiple LED elements are arranged in a matrix, a liquid crystal element including polarizing plates on front and rear substrate surfaces, a projector lens, and a light body housing the light source, the liquid crystal element, and the projector lens.

The front monitoring unit 104 to which a vehicle-mounted camera 108, a radar 110, and various sensors such a vehicle speed sensor 112 are connected performs image processing on captured image data acquired from a sensor, detects a forward vehicle (oncoming car, leading car), other bright objects on the road, a traffic line (lane mark), and so forth, and calculates data required for light-distribution control, such as the attributes and positions of the detected objects. The calculated data is transmitted to the light-distribution control unit 102 and various vehicle-mounted devices via a vehicle-mounted local area network (LAN) or the like.

The light-distribution control unit 102 to which the vehicle speed sensor 112, a steering angle sensor 114, a global positioning system (GPS) navigator 116, a high-beam/low-beam switch 118, and so forth, are connected determines a light-distribution pattern corresponding to a driving scene on the basis of the attributes (oncoming car, leading car, reflector, road lighting) and the positions (front, side) of the bright objects on the road as well as the vehicle speed transmitted from the front monitoring unit 104. In addition, the light-distribution control unit 102 determines the control contents of the adaptive driving beam (turning on/off of the LED element array, light-transmitting/light-shielding pattern of the liquid crystal element) required for providing a light-distribution pattern.

A driver 120 converts information on the control contents (control amounts) transmitted from the light-distribution control unit 102 into commands corresponding to operations of the LED element array and the liquid crystal element, and drives the LED element array and the liquid crystal element.

The vehicular headlight 100 may use the adaptive driving beam according to the embodiment.

In the front-lighting system illustrated in FIG. 15, the adaptive driving beam according to the embodiment is used and thus light-distribution control, such as ADB light distribution and high/low switching, can be performed. The oncoming car is prevented from being dazzled, and assurance and safety are provided for the driver, and, for example, accidents at night can decrease. A configuration without a movable part provides high reliability, and attains reduction in size. Only inserting the liquid crystal element according to the embodiment into a light body of related art can provide requested light distribution. Since the shutter function of the liquid crystal element is used, it is not required to form the lighting pattern of the light source (LED elements). A trouble that a fluorescent body appears yellow when the light source is turned off (the LED elements are turned off) is prevented from occurring. Changing the electrode pattern of the liquid crystal element can form a desirable light-shielding pattern (light-distribution pattern). In the liquid crystal element, even when the number of divisions for pixels increases, the driving circuit is not complicated. Thus, an increase in cost is relatively small when the resolution increases. Travel lanes can be switched merely by changing software. The reflective optical system has complex optical design; however, the optical design is easy when the liquid crystal element is used. Using the liquid crystal element according to the embodiment can provide, for example, light distribution with high white level. The polarizing plates arranged on the front and rear substrate surfaces of the liquid crystal element can emit light as straight polarized light (in a polarized state (p-polarized state) perpendicular to the road), suppresses surface reflection at a water surface or the like, and the oncoming car can be prevented from being dazzled, for example, at raining.

While the present invention has been described above using the embodiments, the present invention is not limited thereto.

For example, while the polarizing plates 33 and 34 are arranged by one each on the front and rear of the liquid crystal element 20 in the adaptive driving beam according to the embodiment, at least one polarizing plate may be arranged on each of the front and rear of the liquid crystal element 20. A polarizing beam splitter may be used instead of a polarizing plate.

In addition, while the optical system using the reflector 32 is used to collect light at the liquid crystal element in the adaptive driving beam according to the embodiment, a lens optical system using, for example, a collimator lens or the like instead of the reflector 32 may be used to collect light.

Furthermore, it is obvious to those skilled in the art that various modifications, improvements, and combinations can be made.

The invention of the subject application can be applied to, for example, vehicular headlights, fog lights, taillights, rear combination lights, and so forth. In addition, the invention of the subject application can be used for a vehicular illumination device having functions, such as ADB light distribution, AFS light distribution, auto-leveling, and high/low switching. In particular, the invention of the subject application can be suitably used for a high/low one-lamp headlight unit. Furthermore, the invention of the subject application can be used for various illumination devices.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the invention have been described in detail, it should be understood that the various changes, substitutions, and alterations could be made hereto without departing from the spirit and scope of the invention.

What are claimed are:

1. A liquid crystal element comprising:
a first substrate and a second substrate disposed substantially in parallel to each other to face each other, an electrode and a homeotropic alignment film being disposed on each of facing surfaces of the first substrate and the second substrate; and
a liquid crystal layer disposed between the first substrate and the second substrate and formed of a liquid crystal material having a negative dielectric-constant anisotropy,
wherein a twisting angle of the liquid crystal layer when a voltage is applied between the electrode of the first substrate and the electrode of the second substrate is in a range from 70° to 120°.

2. A liquid crystal element comprising:
a first substrate and a second substrate disposed substantially in parallel to each other to face each other, an electrode and a homeotropic alignment film being disposed on each of facing surfaces of the first substrate and the second substrate; and
a liquid crystal layer disposed between the first substrate and the second substrate and formed of a liquid crystal material having a negative dielectric-constant anisotropy,
wherein a chiral agent is added to the liquid crystal layer such that d/p is 0.25 or more and 0.4 or less where d is a thickness of the liquid crystal layer and p is a chiral pitch.

3. The liquid crystal element according to claim 2, wherein the liquid crystal layer has anti-parallel alignment.

4. The liquid crystal element according to claim 2, wherein a twist angle of the liquid crystal layer is 90° or 180°.

5. The liquid crystal element according to claim 2, wherein a retardation of the liquid crystal layer is 510 nm or more and 800 nm or less.

6. The liquid crystal element according to claim 5, wherein the retardation of the liquid crystal layer is 620 nm or more and 800 nm or less.

7. The liquid crystal element according to claim 2, further comprising a control device that statically drives the liquid crystal layer by applying a voltage to the electrodes.

8. An illumination device comprising:
a light source that emits light;
a liquid crystal element disposed in an optical path of the light emitted from the light source, the liquid crystal element including
a first substrate and a second substrate disposed substantially in parallel to each other to face each other, an electrode and a homeotropic alignment film being disposed on each of facing surfaces of the first substrate and the second substrate, and
a liquid crystal layer disposed between the first substrate and the second substrate and formed of a liquid crystal material having a negative dielectric-constant anisotropy, a chiral agent being added to the liquid crystal layer such that d/p is 0.25 or more and 0.4 or less where d is a thickness of the liquid crystal layer and p is a chiral pitch; and
a lens on which light emitted from the liquid crystal element is incident, the lens having a focal point at a position near an arrangement position of the liquid crystal element.

9. The illumination device according to claim 8, wherein the light source includes a semiconductor light-emitting element.

10. The illumination device according to claim 8, wherein the light is incident on the liquid crystal element in a direction inclined by 30° or more with respect to a direction normal to the liquid crystal element.
